(19) United States
(12) Patent Application Publication
(10) Pub. No.: US 2025/0292975 A1
(43) Pub. Date: Sep. 18, 2025

(54) PUSH BUTTON ASSEMBLY

(71) Applicant: SUNREX TECHNOLOGY CORP., Taichung City (TW)

(72) Inventors: Jian-Guo GUO, Changshu (CN); Jia-Hui ZHANG, Changshu (CN); Shih-Pin LIN, Taichung City (TW)

(73) Assignee: SUNREX TECHNOLOGY CORP., Taichung City (TW)

(21) Appl. No.: 18/809,693

(22) Filed: Aug. 20, 2024

(30) Foreign Application Priority Data
Mar. 15, 2024 (TW) 113109643

(51) Int. Cl. H01H 17/04

(52) U.S. Cl. CPC H01H 17/04; H01H 2215/028; H01H 2221/002

(57) ABSTRACT

A push button device is adapted for accommodating a substitute pushing module, and the substitute pushing module has a substitute installing plate, and a substitute cap body. The push button device includes a pushing module, a bottom plate, a keycap, a scissor-switch module, and a sensor module. The pushing module includes an installing plate and a cap body. The bottom plate includes a bottom plate body, two limiting portions, and a plurality of lower pivoting joint portions. The limiting portions are adapted for detachably engaging the substitute installing plate of the substitute pushing module to secure the substitute pushing module on the bottom plate when the pushing module is removed.

### CROSS-REFERENCE TO RELATED APPLICATION

This application claims priority to Taiwanese Invention Patent Application No. 113109643, filed on Mar. 15, 2024, the entire disclosure of which is incorporated by reference herein.

### FIELD

The disclosure relates to a push button assembly, and more particularly to a push button assembly having adjustable tactile feedback.

### BACKGROUND

A conventional keyboard switch as disclosed in Taiwanese Invention Patent No. I728209B includes a key cap, a plunger that is engaged with a bottom portion of the key cap, a rubber cap that is disposed at a bottom end of the plunger, a housing that surrounds the plunger and the rubber cap, a plate that is supported by the housing, and a spacer that is disposed between the plate and the key cap. The spacer may be installed to or uninstalled from the conventional keyboard device to alter a keystroke of the conventional keyboard switch.

However, for the conventional keyboard switch, only the customization of the length of keystrokes is provided to fulfill needs like faster quick combos in gaming or faster typing speeds, and other customizable features are not offered. Hence, there is room for improvement in related fields.

### SUMMARY

Therefore, an object of the disclosure is to provide a push button device that can alleviate at least one of the drawbacks of the prior art.

According to the disclosure, the push button device is adapted for accommodating a substitute pushing module. The substitute pushing module has a substitute installing plate and a substitute cap body. The substitute cap body is connected to a top side of the substitute installing plate and is deformable under a peak force. The push button device includes a pushing module, a bottom plate, a keycap, a scissor-switch module, and a sensor module. The pushing module includes an installing plate and a cap body. The cap body is connected to a top side of the installing plate, and is deformable by a peak force that is adapted to be different from the peak force under which the substitute cap body is deformable. The bottom plate includes a bottom plate body, two limiting portions, and a plurality of lower pivoting joint portions. The two limiting portions upwardly extend from the bottom plate body, are spaced apart from each other, detachably engage the installing plate, and are adapted for detachably engaging the substitute installing plate of the substitute pushing module to secure the substitute pushing module on the bottom plate when the pushing module is removed. The plurality of lower pivoting joint portions upwardly extend from the bottom plate body. The keycap is disposed above the bottom plate, and has an outer surface, an inner surface opposite to the outer surface, and a plurality of upper pivoting joint portions extending from the inner surface. The scissor-switch module is connected between the lower pivoting joint portions and the upper pivoting joint portions. The sensor module is disposed between the keycap and the bottom plate body, and is formed with two limiting holes and a plurality of pivoting joint holes. The limiting portions respectively extend through the limiting holes. The lower pivoting joint portions respectively extend through the pivoting joint holes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a push button device according to the disclosure.

FIG. 2 is a schematic exploded perspective view of the embodiment.

FIG. 3 is a fragmentary perspective view of the embodiment, illustrating a bottom plate, a sensor module, and a pushing module.

FIG. 4 is a sectional view of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

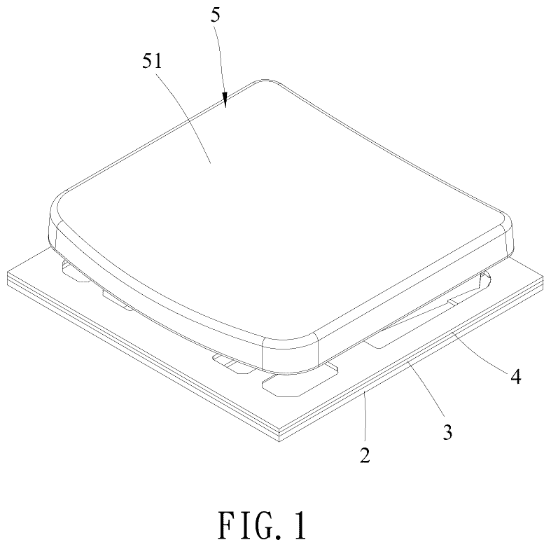

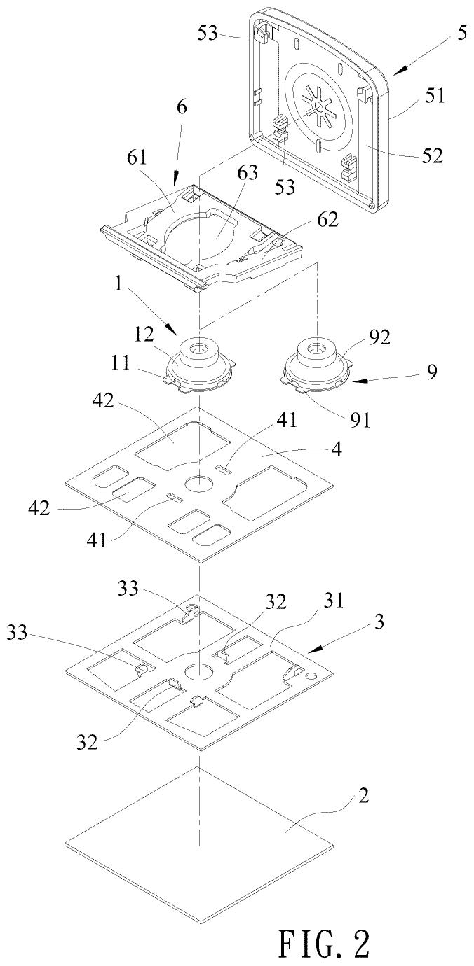

Referring to FIGS. 1 and 2, an embodiment of a push button assembly according to the disclosure includes a pushing module 1, a substitute pushing module 9, a circuit board 2, a bottom plate 3, a sensor module 4, a keycap 5, and a scissor-switch module 6. In other variations of the embodiment, a number of the keycap 5 and a number of the scissor-switch module 6 may be changed to a number greater than one.

The substitute pushing module 9 has a substitute installing plate 91, and a substitute cap body 92 that is connected to a top side of the substitute installing plate 91. The substitute pushing module 9 is deformable under a peak force, has a click ratio, and will rebound under a rebound force. In this embodiment, a material of the substitute installing plate 91 is stainless steel, and a material of the substitute cap body 92 is rubber. In other embodiments, the material of the substitute installing plate 91 may be aluminum (Al) or polyethylene terephthalate (PET).

The pushing module 1 includes an installing plate 11, and a cap body 12 connected to a top side of the installing plate 11. The pushing module 1 is deformable by a peak force that is different from the peak force under which the substitute cap body 92 is deformable, and will rebound under a rebound force different from the rebound force of the pushing module 1. The pushing module 1 and the substitute pushing module 9 have different click ratios. Specifically, the pushing module 1 and the substitute pushing module 9 may have different structures and different manufacturing processes, or may be made from different materials to have different click ratios and are deformable by different peak forces and will rebound under different rebound forces.

In this embodiment, a material of the installing plate 11 is stainless steel, and a material of the cap body 12 is rubber. In other embodiments, the material of the installing plate 11 may be Al or PET.

The circuit board 2 is a printed circuit board. In other variants of the embodiment, the circuit board 2 may be a flexible printed circuit board.

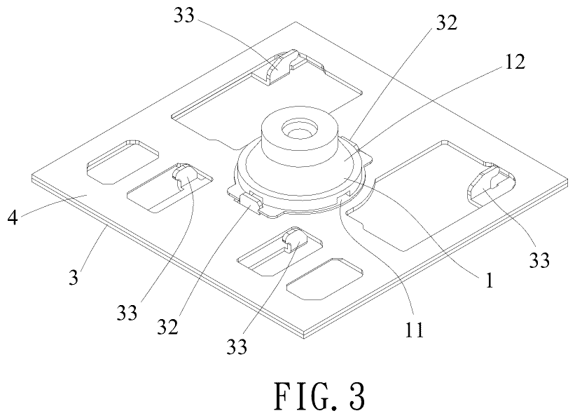

Referring to FIGS. 2 and 3, the bottom plate 3 is mounted to a top surface of the circuit board 2, and includes a bottom plate body 31, two limiting portions 32 upwardly extending from the bottom plate body 31 and spaced apart from each other, and a plurality of lower pivoting joint portions 33 upwardly extending from the bottom plate body 31. The two limiting portions 32 detachably engage the installing plate 11 of the pushing module 1 to secure the pushing module 1 on the bottom plate 3, and can detachably engage the substitute installing plate 91 of the substitute pushing module 9 to secure the substitute pushing module 9 on the bottom plate 3 when the pushing module 1 is removed. In this embodiment, a number of the lower pivoting joint portions 33 is four.

The sensor module 4 is disposed between the keycap 5 and the bottom plate body 31, and is formed with two limiting holes 41 and a plurality of pivoting joint holes 42. The limiting portions 32 respectively extend through the limiting holes 41. The lower pivoting joint portions 33 respectively extend through the pivoting joint holes 42. The sensor module 4 is electrically connected to the circuit board 2, and when the keycap 5 is pressed, the sensor module 4 generates a pressing signal based on a pressing condition of the keycap 5, and transmits the pressing signal to the circuit board 2. The method of the pressing signal being generated and transmitted is known in the prior art and is not a distinctive feature of the disclosure; hence, it will not be described in further detail. In this embodiment, the sensor module 4 is a membrane switch.

The keycap 5 is disposed above the bottom plate 3, the sensor module 4, and the scissor-switch module 6, and has an outer surface 51, an inner surface 52 opposite to the outer surface 51, and a plurality of upper pivoting joint portions 53 extending from the inner surface 52. In this embodiment, a number of the upper pivoting joint portions 53 is four.

The scissor-switch module 6 is connected between the lower pivoting joint portions 33 and the upper pivoting joint portions 53, and is disposed above the sensor module 4, the bottom plate 3, and the circuit board 2. The scissor-switch module 6 includes a first frame 61 that is rotatably connected to two of the upper pivoting joint portions 53 and two of the lower pivoting joint portions 33, and a second frame 62 that is rotatably connected to the remaining upper pivoting joint portions 53 and the remaining lower pivoting joint portions 33. The first frame 61 and the second frame 62 are pivotably connected to each other, are connected on a pivot, and cooperatively define an installation space 63. The installation space 63 receives the pushing module 1, and receives the substitute pushing module 9 when the pushing module 1 is removed.

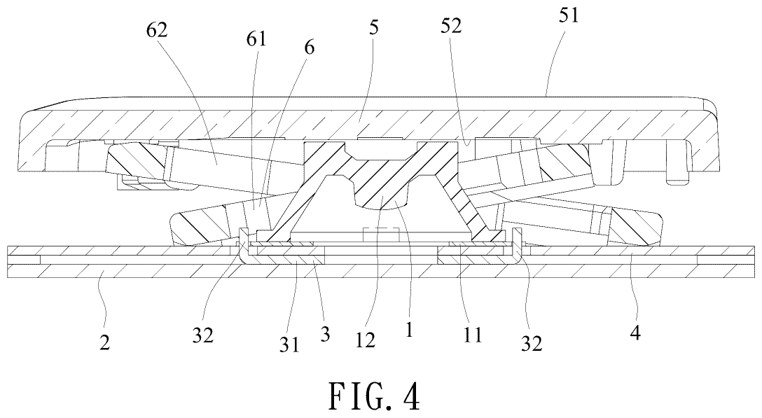

Referring to FIGS. 2 and 4, the push button assembly provides a first tactile feedback when the pushing module 1 is installed. Specifically, referring to FIG. 4, when the pushing module 1 is installed, the pushing module 1 engages the limiting portions 32 of the bottom plate 3, and the cap body 12 is disposed in the installation space 63, which provides a supporting force to the inner surface 52 of the keycap 5 that is equivalent to the peak force of the pushing module 1.

Similarly, the push button assembly provides a second tactile feedback when the pushing module 1 is removed and the substitute pushing module 9 is installed. Specifically, when the pushing module 1 is replaced by the substitute pushing module 9, the substitute installing plate 91 of the substitute pushing module 9 is detachably engaged with the limiting portions 32 of the bottom plate 3, the substitute cap body 92 is disposed in the installation space 63, and the substitute pushing module 9 provides a supporting force to the inner surface 52 of the keycap 5 that is equivalent to the peak force of the substitute pushing module 9. A drawing of the substitute pushing module 9 being engaged with the limiting portions 32 is not shown, as the details thereof may be inferred from the abovementioned description.

Hence, the advantages of the push button assembly are as follows.

The limiting portions 32 of the bottom plate 3 is detachable from the installing plate 11, so a process of installing the pushing module 1 on or uninstalling the pushing module 1 from the bottom plate 3 is easier, thereby increasing substitutability between the pushing module 1 and the substitute pushing module 9.

The installation space 63 that is cooperatively defined by the first and second frames 61, 62 may receive the pushing module 1, or the substitute pushing module 9 when the pushing module 1 is removed, and allows the scissor-switch module 6 to be spaced apart from the pushing module 1, or to be spaced apart from the substitute pushing module 9 when the substitute pushing module 9 is disposed in the installation space 63 and the pushing module 1 is removed, so that a process of installing the pushing module 1 on or uninstalling the pushing module 1 from the bottom plate 3 is easier, thereby increasing substitutability between the pushing module 1 and the substitute pushing module 9.

Hence, an objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A push button device adapted for accommodating a substitute pushing module, the substitute pushing module having a substitute installing plate, and a substitute cap body that is connected to a top side of the substitute installing plate and that is deformable under a peak force, the push button device comprising:
a pushing module that includes
an installing plate, and
a cap body connected to a top side of said installing plate, and deformable by a peak force that is adapted to be different from the peak force under which the substitute cap body is deformable;
a bottom plate that includes
a bottom plate body,
two limiting portions upwardly extending from said bottom plate body, spaced apart from each other, detachably engaging said installing plate, and adapted for detachably engaging the substitute installing plate of the substitute pushing module to secure the substitute pushing module on said bottom plate when said pushing module is removed, and
a plurality of lower pivoting joint portions upwardly extending from said bottom plate body;
a keycap that is disposed above said bottom plate, and that has
an outer surface,
an inner surface opposite to said outer surface, and
a plurality of upper pivoting joint portions extending from said inner surface;
a scissor-switch module that is connected between said lower pivoting joint portions and said upper pivoting joint portions; and
a sensor module that is disposed between said keycap and said bottom plate body, and that is formed with two limiting holes and a plurality of pivoting joint holes, said limiting portions respectively extending through said limiting holes, said lower pivoting joint portions respectively extending through said pivoting joint holes.

2. The push button device as claimed in claim 1, wherein:
a number of said upper pivoting joint portions is four;
a number of said lower pivoting joint portions is four;
said scissor-switch module includes
a first frame rotatably connected to two of said upper pivoting joint portions and two of said lower pivoting joint portions, and
a second frame rotatably connected to the remaining upper pivoting joint portions and the remaining lower pivoting joint portions; and
said first frame and said second frame are pivotably connected to each other.

3. The push button device as claimed in claim 2, wherein said first and second frames are connected on a pivot and cooperatively define an installation space, said installation space receiving said pushing module and being adapted for receiving the substitute pushing module when said pushing module is removed.

4. The push button device as claimed in claim 1, wherein a material of said installing plate is one of stainless steel, aluminum, and polyethylene terephthalate.

5. The push button device as claimed in claim 1, wherein a material of said cap body is rubber.

6. The push button device as claimed in claim 1, wherein said sensor module is a membrane switch.

7. A push button assembly comprising:
a substitute pushing module that has
a substitute installing plate, and
a substitute cap body connected to a top side of said substitute installing plate, and deformable by a peak force; and
a push button device as claimed in claim 1;
wherein said substitute plate of said substitute pushing module is detachably engageable with said limiting portions of said bottom plate when said pushing module is removed.

8. The push button assembly as claimed in claim 7, wherein said cap body and said substitute cap body have different click ratios.
